(19) United States
(12) Patent Application Publication
(10) Pub. No.: US 2023/0015950 A1
(43) Pub. Date: Jan. 19, 2023

(54) METHOD AND SYSTEM FOR CONVERTING DATABASE APPLICATIONS INTO BLOCKCHAIN APPLICATIONS

(71) Applicant: Zeu Technologies, Inc., Montreal (CA)

(72) Inventors: Yuming QIAN, Richmond Hill (CA); Francois DUMAS, Montreal (CA); Patricia POPERT-FORTIER, Dorval (CA)

(73) Assignee: Zeu Technologies, Inc., Montreal, QC (CA)

(21) Appl. No.: 17/779,977

(22) PCT Filed: Nov. 26, 2020
(86) PCT No.: PCT/CA2020/051613

§ 371 Date: May 25, 2022

Related U.S. Application Data
(60) Provisional application No. 62/940,620, filed on Nov. 26, 2019.

(51) Int. Cl. G06F 9/48; G06F 16/23

(52) U.S. Cl. CPC G06F 9/48; G06F 16/2308

(57) ABSTRACT

A method and system for converting database applications into blockchain applications is disclosed. Multiple applications on different nodes can automatically perform global data consensus to prevent data conflicts using the embodiments described. One method involves monitoring databases as they is modified by database applications, to extract data operations from transaction logs, convert the data operations to a general format, and activate the smart contract on the blockchain to complete the data consensus check at multiple nodes. Each node monitors the blocks on blockchain and synchronizes the data back to database. In the case of conflicting data, the data is not able to pass consensus and synchronize with the other nodes in the blockchain. The local nodes automatically roll back when detecting invalid data.

### TECHNICAL FIELD

The present application relates generally to a blockchain system, and in particular to a method and system for converting database applications into blockchain applications.

### BACKGROUND ART

Many traditional enterprise software applications are database applications, and often many business services are built upon relational or non-relational databases. A common problem in the process of migrating enterprise database applications to blockchain applications is that the overall structure of blockchains is very different from structure of traditional databases used by enterprise applications. Enterprise applications must be significantly modified or even rewritten to fit within the structure and mode of operation of a blockchain.

Enterprise applications typically contain vast amounts of private or confidential data whereas blockchain is essentially a distributed ledger technology that promotes transparency of transactions among participants. It is therefore neither necessary nor desirable to have the private portions of enterprise data written into the blockchain. Even blockchain-based enterprise applications are thus dependent on databases.

Not surprisingly, in the real world applications, many blockchain applications are hybrid applications where some data resides the blockchain, a while other private data is stored locally often in a database. The problem then becomes how locally stored data is synchronized with the blockchain.

In a typical scenario, where a product is traced through various stages, information about the product is written into the blockchain at every stage such as at production, logistics and sales. At the same time, it is necessary to prevent an unauthorized node from writing data or otherwise prevent incorrect data from being entered. For example, if a given product has already progressed to the sales stage, the manufacturer should be prevented from altering and inserting production data into the blockchain. Supply chain finance works in a similar fashion. Process data is recorded from raw material storage to product delivery, logistics, wholesale, and retail sales. During this process, each node generates large amounts of data about the product, synchronizes the data with each participant, and rejects certain messages—all of which constitutes a considerable workload for traditional applications. Furthermore, if a purely blockchain system is used, synchronization of the blockchain data and database data stored in local ERP (enterprise resource planning) and CRM (customer relationship management) systems presents a difficult technical challenge.

Accordingly improved systems and methods of combining traditional database applications with blockchain technology are desired to mitigate at least some of these problems.

### SUMMARY OF INVENTION

In accordance with one aspect of the present invention there is provided a system including: a first adapter in communication with a first database and a blockchain; a second adapter in communication with a second database and the blockchain. The blockchain includes at least a first node and a second node, a first application running on the first node using the first database: a second application running on the second node using the second database; wherein the first and second adapters monitor transaction logs for the first and second databases respectively to: extract data operations from the transaction logs; convert the data operations to a general format; and activate a smart contract on the blockchain to complete consensus voting at said first and second nodes.

In accordance with another aspect of the present invention there is provided a method of migrating a database application using a database to a blockchain. The method includes: monitoring a log of the database and identifying a database command to be validated by the blockchain; providing a status column in the database for a table affected by the identified database command; executing a first command, based on the database command, to set the status column to a first value; submitting a blockchain command corresponding to the identified database command to the blockchain for validation; upon receiving validation from the blockchain, updating the database by executing a second command, based on the database command, to set the status to a second value different from the first value; and otherwise rolling back the database command.

In accordance with another aspect of the present invention there is provided a system for migrating a database application using a database to a blockchain application using a blockchain, without modifying the application. The system includes an adapter comprising a database proxy and a blockchain interface, the adapter comprising processor executable instructions that when executed on a processor configure the processor to perform the steps of: monitoring a log of the database and identifying a database command to be validated by the blockchain; providing a status column in the database for a table affected by the identified database command; executing a first command, based on the database command, to set the status column to a first value; submitting a blockchain command corresponding to the identified database command to the blockchain for validation; upon receiving validation from the blockchain, updating the database by executing a second command, based on the database command, to set the status to a second value different from the first value; and otherwise rolling back the database command.

In accordance with another aspect of the present invention there is provided a method of applications running on nodes connected to a blockchain, the method comprising: monitoring transaction logs for databases used by the applications as the databases are modified by database applications; extracting data operations from transaction logs; converting the data operations to a general format; and activating a smart contract on the blockchain to complete the data consensus check at said multiple nodes.

In accordance with yet another aspect of the present invention there is provided a method of synchronizing a first database associated with a first node of a blockchain with a second database associated with a second node on the blockchain, the method including: at the first node: retrieving a log from a message queue of transaction logs for the first database; identifying a transaction from the log and storing the transaction data in a predetermined format; invoking a smart contract based the log to store the transaction data into a blockchain; and at the second node: retrieving the transaction data from the blockchain; executing a first command associated with the transaction data to store the transaction in the second database.

### BRIEF DESCRIPTION OF DRAWINGS

In the figures, which illustrate by way of example only, embodiments of the present invention,

FIG. 1 is a simplified schematic diagram of a system, exemplary of an embodiment of the present invention;

FIGS. 2A-2C. illustrate a flowchart, summarizing steps in an exemplary process, including steps for simple modification of the database commands;

FIG. 3A is simplified schematic diagram of two applications utilizing a common database;

FIG. 3B is simplified schematic diagram of multiple database applications that are synchronized with blockchain data; and

FIG. 4 is a schematic diagram of a supply chain system, exemplary of an embodiment of the present invention, utilizing multiple database applications having a local database that are synchronized via interaction with a blockchain.

### DESCRIPTION OF EMBODIMENTS

At least some embodiments of the present invention address challenges related to migrating database applications to blockchain applications. These include automatic conversion and synchronization of at least key select data in the database with the blockchain, thereby synchronizing database data of other nodes. In at least some embodiments, adapters are used to facilitate data exchange between local databases and the blockchain which frees the applications themselves to run without any knowledge of the blockchain.

A description of various embodiments of the present invention is provided below. In this disclosure, the use of the word “a” or “an” when used herein in conjunction with the term “comprising” may mean “one”, but it is also consistent with the meaning of “one or more”, “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like. Directional terms such as “top”, “bottom”, “upwards”, “downwards”, “vertically” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

A “blockchain” is a tamper-evident, shared digital ledger that records transactions in a public or private peer-to-peer network of computing devices. The ledger is maintained as a growing sequential chain of cryptographic hash-linked blocks.

A “node” is a device on a blockchain network. The device is typically be a computer having a processor interconnected to a processor readable medium including memory, having processor readable instructions thereon.

In addition, the terms “first”, “second”, “third” and the like are used for descriptive purposes only and cannot be interpreted as indicating or implying relative importance.

In the description of the invention, it should also be noted that the terms “mounted”, “linked” and “connected” should be interpreted in a broad sense unless explicitly defined and limited otherwise. For example, it could be fixed connection, or assembled connection, or integrally connected; either hard-wired or soft-wired; it may be directly connected or indirectly connected through an intermediary. For technical professionals, the specific meanings of the above terms in the invention may be understood in context.

In the drawings illustrating embodiments of the present invention, the same or similar reference labels correspond to the same or similar parts. In the description of the invention, it should be noted that the meaning of “a plurality of” means two or more unless otherwise specified; The directions or positions of the terms “up”, “down”, “left”, “right”, “inside”, “outside”, “front end”, “back end”, “head”, “tail”, the orientation or positional relationship shown in the drawings is merely for the convenience of describing the invention and simplifying the description rather than indicating or implying that the indicated device or element must have a particular orientation and be constructed and operated in a particular orientation, and therefore cannot be used as a limitation of the invention.

In addition, “chain” is typically interchangeably used with “blockchain” unless otherwise specified or the context clearly indicates otherwise.

### Basic System Architecture

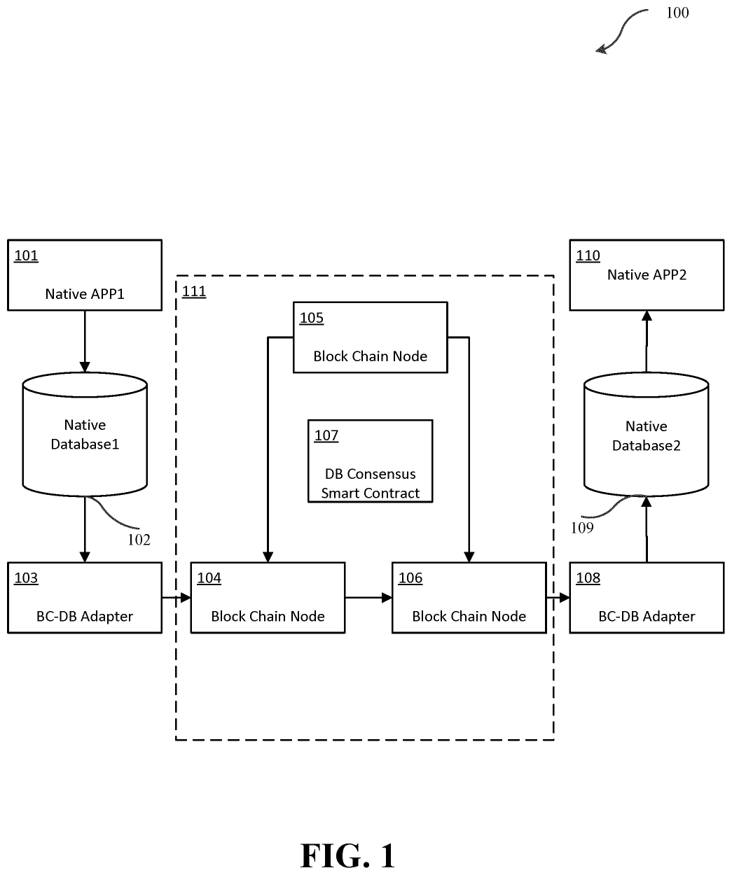

FIG. 1 depicts a schematic diagram of a system 100, exemplary of an embodiment of the present invention. A first database application 101 exchanges data with a first database 102. A second database application 110 is in data communication with a second database 109. The databases 102, 109 may be local databases.

A first blockchain-database adapter 103 includes a database plug-in for real-time listening or monitoring of a log for database 102 and a blockchain plug-in or interface to interact with a blockchain 111.

A second blockchain-database adapter 108 includes a database plug-in for real-time listening or monitoring of the log for database 109 and a blockchain plug-in or interface to interact with the blockchain 111.

Nodes 104, 105, 106 are blockchain nodes that are deployed in different organizations, and complete the distributed accounting and run smart contracts such as smart contract 107.

Application 101 may be a native database application written in any language. As the application 101 interacts with the database 102 it need not have any knowledge of the blockchain 111.

Database 102 may be a local NoSQL database, or a relational database management system utilizing SQL (structured query language) such as Oracle™, or MySQL™. Alternately database 102 may be MongoDB, Cassandra, and the like. Database 102 is configured to generate a database log such as the BINLOG or REDO log, which records details of all related local transactions. If database 102 does not support the log, alternative methods are implemented to scan the database periodically and identify changes. This could be a task job or a trigger in the database 102.

Blockchain-database adapter 103 in this embodiment includes two plug-ins: the database plug-in for real-time listening and/or parsing of the database log and blockchain plug-in to interact with the blockchain 111.

The database plug-in converts the database change record to a standardized JSON string in the format {“Transactionid”: “XXX”, {“Table”: “Salary”, {“operation”: “delete”}, “before”: {[{“col1”: “a1”, “co12”: “b1”}, {“col1”: “a2”, “col2”: “b2”} . . . ]}, “after”: {[{“col1”:“A11”, “col2”: “b11”} {“col1”: “a22”, “col2”: “b22”} . . . ]}}}

Blockchain-database adapter 103 may use different plug-ins for different blockchains and passes the standardized JSON (JavaScript Object Notation) strings to the blockchain smart contract for global consensus.

Smart contract 107 running in the blockchain node, performs verification on submitted data according to the following contract rules: (1) the data submission account belongs to a legal account and the content of the submitted data matches the account's privilege; (2) the data type and the data range is legal.

Each piece of software such as application 101, associated plugins, adapter 103, database 102 smart contracts and the like utilized in embodiments of the present invention are run or executed on a device, typically be a computer, having a processor interconnected to a processor readable medium including memory, having processor readable instructions or processor executable instructions thereon. These instructions, when executed, perform the steps encoded therein as will be discussed later. The computing devices may be in the form of nodes, server computers or other server or client devices, depending on the particular piece of software being executed.

For example, in the supply chain, a first account belongs to the manufacturer, a second account belongs to the logistics provider and a third account belongs to the retailer. The smart contract checks whether production-related data is submitted using the manufacturer's key. In this example, the first account or manufacturer's account can only provide production-related data and does not have the right to provide logistical or consumption data. Moreover, some of the data provided is prohibited from being modified.

Blockchain-database adapter 108 monitors the local changes in database 109 in real-time and further monitors transactions in all new blocks on the blockchain 111 in real-time. Adapter 108 filters out transactions related to local data, and converts the data to database operations. By executing the database operation, the blockchain data is kept synchronized to the local database. For example, data associated with an insert operation is restored locally to one or more insert SQL statements and executed in the local database. If the execution fails, the data is deleted first and the SQL command is executed again, ensuring that the local record is consistent with the consensus record in the blockchain.

### Data Synchronization of a Database Application Through a Blockchain

The present disclosure provides a method of operation for completing data synchronization of database applications through a blockchain, and the steps thereof.

In one exemplary embodiment, to enable a database to record a temporary data status of a record which is committed in the local environment but waiting for global consensus, an extra status column (e.g., called “BCStatus”) is added or appended to each affected table that has data records that need to be synchronized to the blockchain. The extra status column may generally have a value that is selected from an enumerated set of predetermined values. For example, the extra status column may be a Boolean data type which can only be set to one of two values such as “true” or “false”; “0” or “1”; or the like. In this exemplary embodiment, the default value of the extra status column is “0”, and after receiving confirmation from the blockchain, the value is changed to “1”. This value of the extra status column also provides means for local applications to detect the global consensus status.

In one embodiment, to prevent data conflicts between the local data and the global data, any database record that needs to be synchronized to the blockchain must have “BCStatus” in the “before” section set to “1”. After the adapter accepts the data, the local value of “BCStatus” is reset to “0” until getting confirmation from consensus, which restores the value to “1”.

One simple way to prevent overwriting data that has not been confirmed by the blockchain yet is as follows. When a modification of data is performed on the application, rewrite the SQL command by adding an extra condition related to the extra status column.

For example, suppose an application ordinarily performs the following update operation on a table named “employee” having the columns “salary”, “name” and others.

UPDATE employee SET salary = 10000
WHERE name = “oliver”

The SQL is rewritten as:

UPDATE employee SET salary = 10000 AND BCStatus = 0
WHERE name = “oliver” AND BCStatus = 1

The rewrite of the SQL command may be done in a module or in the application itself or using a front side database proxy (DB proxy) prior to execution by the database.

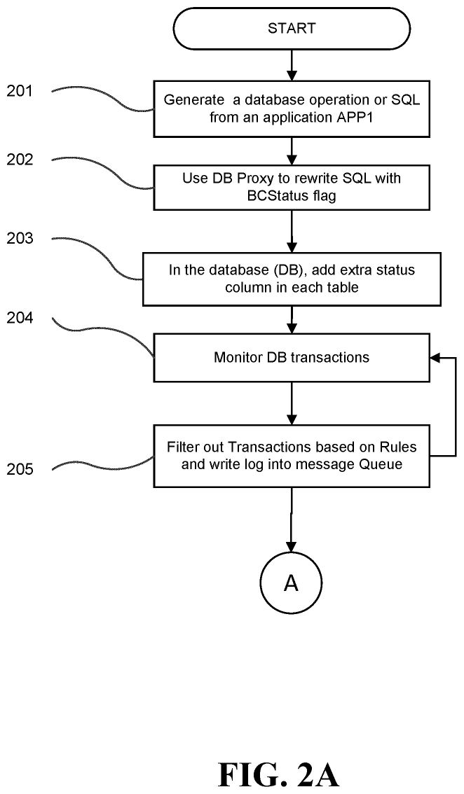

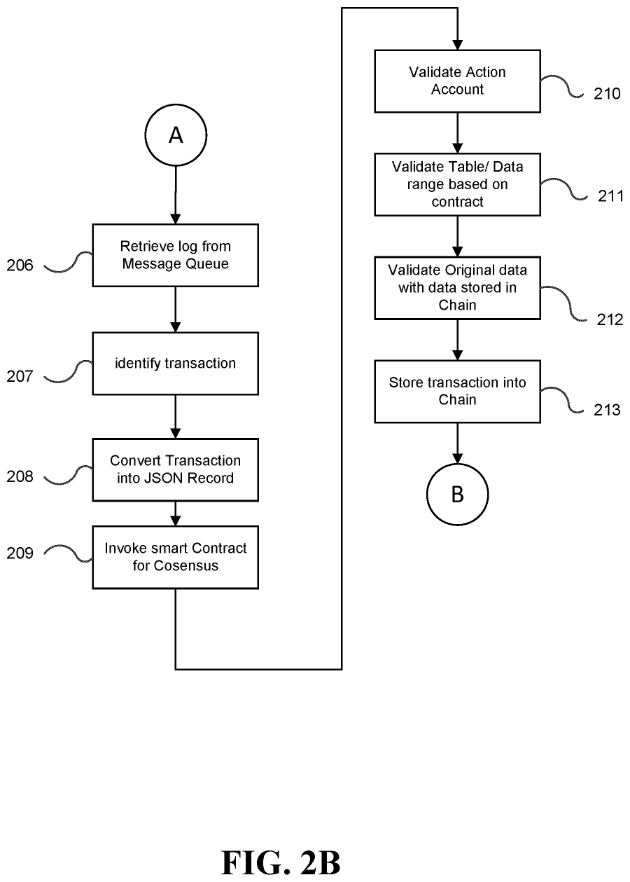

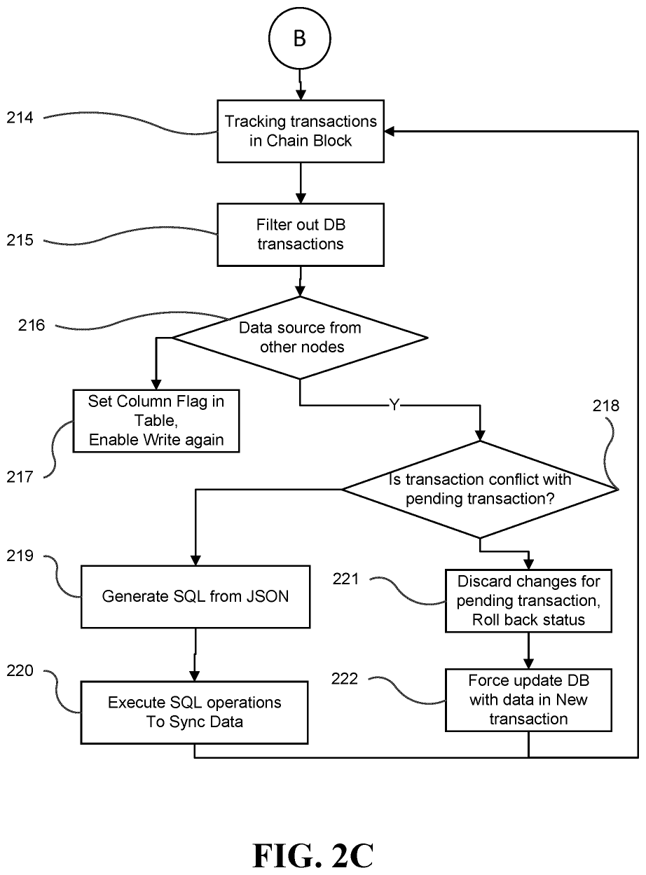

An exemplary process involving the above steps is illustrated using a flowchart depicted in FIGS. 2A-2C.

As shown in FIG. 2A, at step 201 a native application executes a database transaction, which may involve insert, update or delete operations. This generates an SQL command or statement in this exemplary embodiment. Each operation may involve multiple lines of data.

At step 202 a DB proxy or an in-app modifier module rewrites the SQL statement to add an extra condition in the form of a flag for the extra status column into the table, as discussed earlier. Alternately a database trigger may be used. In this embodiment, when writing data, the status of the extra column is set to a value of “0” to prevent overwriting with unconfirmed data.

At step 203 the database executes the transaction, sets the extra status column value, and generates transaction logs.

At step 204 the database is monitored by tracking changes in database logs through an appropriate plug-in. As noted above, different databases may use different corresponding plug-ins for tracking changes in the database.

At step 205, as only a subset of the data in the database needs to be synchronized to the blockchain, local data not required for blockchain synchronization is filtered out while data relevant for synchronization with the blockchain is written to the blockchain.

In this embodiment, a local persistent message queue is used to temporarily cache the data because database transactions may occur at a rate that is faster than data writing operations in blockchain services. To prevent data loss, the filtered blockchain data is put into cache or buffer before being processed in the blockchain.

At step 206 data is retrieved from the persistent message queue. The message queue acts as the local cache here and unlike an in-memory cache, it is persistent and thus data is safely preserved even in the event of loss of system power.

At step 207 the event is identified from the log retrieved from the message queue.

As step 208 the transaction log is converted into standardized JSON format. The JSON includes the following sections: Table of Operation, Operation Methods, Data Values Before Change, and Data Values After Change.

At step 209 the adapter invokes a smart contract in the blockchain and validates the data, then inputs the JSON string in the smart contract.

If the smart contract validation fails, the record is not placed into the blockchain, and the adapter executes the rollback operation in the local node. In a rollback, the adapter changes the database record back to the pre-transaction status, which replaces the values in the database with the values of the “before” section. The operation should also be reversed: “insert” changes to “delete” and “delete” changes to “insert”. For example, if the table is called “people” having a column called “id”, and the transaction SQL statement is:

INSERT people VALUES (1, “oliver”,“1000.00”)

then the rollback SQL should be:

DELETE FROM people WHERE id=1.

Similarly, if transaction SQL is:

DELETE FROM people WHERE id=1

Then, the rollback SQL should be:

INSERT people VALUES (1, “oliver”,“1000.00”).

The values are extracted from the “before” section of the transaction log.

At step 210 the smart contract validates the action account; the account should be valid and allowed to modify the data.

At step 211 the smart contract is based on agreement, validates the range of table and data, and makes sure the account has the appropriate privilege to modify the data. For example, in a supply chain application having manufacturing, transportation and sales data, a factory should only change manufacturing data status. The factory should not be able to modify transportation or sales data.

At step 212 the contract also validates the “before” part of the data with the data stored in the blockchain. If it is different, that means the data has been modified, and the data is not synchronized to blockchain and thus, the modification is rejected.

At step 213 the contract performs other validations on the data based on defined rules, and after all validations have been passed, the modification record is stored on the blockchain.

At step 214 a blockchain monitor is deployed to track all the blocks on the chain or blockchain either on the same node or a different node in the blockchain. When the block height reaches the irreversible limit, signifying that the block cannot be changed any further, and tracker extracts transactions from the block.

At step 215, a filter is provided to filter out non-database related transactions. On a given blockchain, there may be many kinds of transactions. However, in this embodiment, only database related transactions are of interest.

At step 216 the source node of the transaction is checked, and if it is the same node as the current node, the process goes to step 217 to update the extra status column (BCStatus flag) on the local database to allow the modification of data again. Otherwise, the process goes to step 218 for further processing.

A step 217, if a local transaction is confirmed globally through the blockchain, the adapter modifies the BCStatus for all affected records.

At step 218 if two nodes are trying to modify the same record simultaneously, have both executed successfully in the local node, and have sent the records to the blockchain for consensus then since step 212 verifies the “before” values of records, only one transaction can pass the blockchain validation. In that case, all confirmed records are made to update the values in the local record.

At step 219 an SQL statement is generated with “after” values in JSON, and forces an update to the records in the database with “after” values. If the operation is a “delete” operation, a delete SQL statement is executed. If the operation is an “insert” operation, and there is already something in the local data, then the “delete” statement is executed first and then “insert” statement is executed thereafter. All modified values have “BCStatus” as 1.

At step 220, the SQL statement is executed in the local database.

At step 221, if the transaction conflicts with the local data, an update of the local data is made by simply updating the local values with the “after” values in the JSON record.

At step 222, the SQL statement is executed in the local database. In case of an abnormal termination, the statement can be executed repeatedly until it succeeds.

Having described the common major steps involved in migrating database applications to a blockchain, examples of the application of these embodiments to specific scenarios will now be described.

I. Electronic Certificate Example

In this application scenario, an electronic record that is generated locally needs to be retrieved later for confirmation, such as legal documents, bank orders, etc.

Traditionally, a centralized database has been used to store the data and validate and resolve conflicts. Using a method exemplary of an embodiment of the present invention, traditional database-based applications are be easily converted to a blockchain-based decentralized system and expanded to multiple organizations.

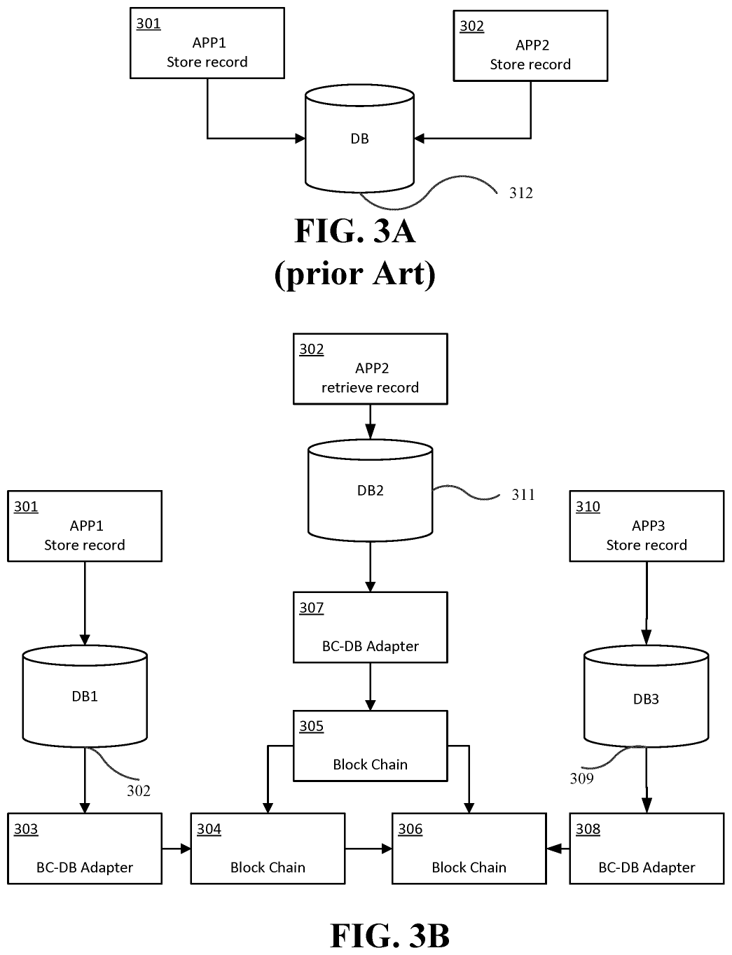

As depicted in FIG. 3a, in a traditional environment, all applications 301, 302 must be based on the same centralized database 312 to store and verify the data.

Using methods exemplary of an embodiment of the present invention, there is no need to modify the application code to migrate the application to a blockchain environment.

As shown in FIG. 3b, instead by inserting the blockchain-database (BC-DB) adapters 303, 307, 308 between the databases 302, 311, 309 and the blockchain in each node 304, 305, 306 respectively, and by selecting the fields in the respective database, automatically synchronization of all other databases is achieved through the blockchain. Conflicts between blockchain data and database records are resolved by the respective adapter. All the changes from database 303 denoted DB1 and database 309 denoted DB3 are synchronized to database 311 denoted DB2, and application 302, denoted APP 2 could query all confirmed data.

II. Supply Chain Example

For supply chain applications, there are often different participants, such as part suppliers, manufacturers, logistic companies, retailers, banks, and the like. Product information data needs to be shared between different organizations. Suppliers write records for parts supplied to the manufacturer. Manufacturers write product information and the parts used in each individual product. Logistic companies write details regarding product transportation. Retailers write product sales information. The bank needs all the aforementioned information to issue loans.

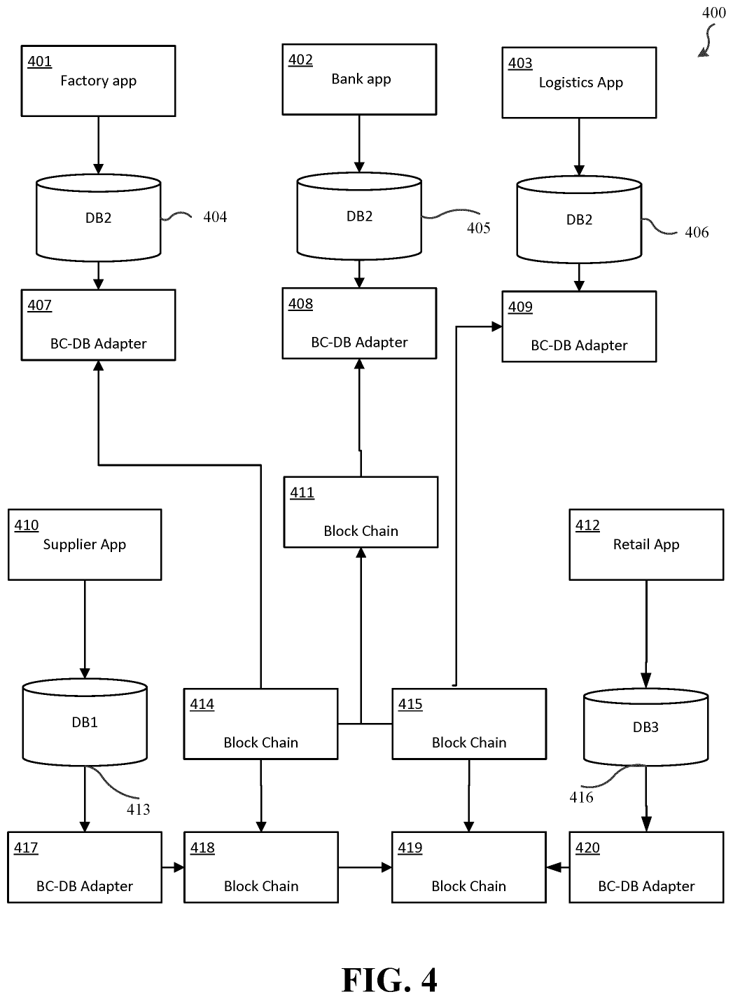

FIG. 4 depicts a schematic diagram of a supply chain system 400 exemplary of the above described embodiment. Supply chain system 400 includes a factory application 401, a bank application 402, a logistics application 403, a supplier application 410 and a retail application 412 that use data stores or databases 404, 405, 406, 413, 416 respectively.

Factory application 401, a bank application 402, a logistics application 403, supplier application 410 and retail application 412 utilize adapters 407, 408, 409, 417, 420 to exchange data with blockchain nodes 414, 411,415, 418, 419 respectively.

By utilizing adapters 407, 408, 409, 417, 420 each with an interface or plug-in suited to its respective database, databases on different nodes can be synchronized to achieve impressive overall results. The part supplier gets access to inventory data at the manufacturer and can prepare parts in advance, thereby shortening lead-time requirements. The logistic company may access product data even if the product or data is still at the manufacturer, and can arrange vehicles and other transportation logistics in advance. The manufacturer receives the retail data to help plan the manufacturing cycle to better suit market needs. The bank may access all of the above data from different nodes to detect potential fraud and arrange financing and issue loans to participants.

Contributions of the present disclosure include the following.

A method and system for converting a database-based application into a blockchain-based application, characterized by a data adaptation layer provided between an underlying database layer and the blockchain is provided. The adaptation layer monitors the transaction logs of database, extracts relevant data change operations, and sends data change operations to the blockchain for global consensus processing. The adaptation layer simultaneously obtains data consensus results from the blockchain and synchronizes the data changes on other nodes to the local database. Global data consensus among the databases is performed through smart contracts in the blockchain.

In addition to what is noted above, the application first completes the corresponding database transaction locally, which may involve both local data and data needing to be synchronized to the blockchain. An additional field in the local database table is added to record the global consensus status.

In addition to what is noted above, the database application operation may need minor modifications to engage the extra consensus status as a filter.

In addition to what is noted above, the blockchain database adapter adapts different databases and intercepts multiple data change records through a plug-in mode, including but not limited to relational databases, non-relational databases, etc., and uniformly formats the data change records into general JSON data change records. The recorded content includes all data operations in the same local transaction, the data state before the data change, the data operation method (add, delete, change), and the data state after the local transaction execution.

In addition to what is noted above, the data change record is compared with a predefined data filter to determine whether there is data in the transaction operation that needs to be synchronized to the blockchain. The data filter includes a data feature filtering, database, table name, data range, etc. When the data satisfies the filter rules, the general format of the JSON data package is submitted to smart contracts in the blockchain for global consensus.

In addition to what is noted above, the smart contract in the blockchain verifies the validity of the data at multiple nodes. Multiple nodes in the blockchain vote and generate the consensus results.

After the smart contract verifies the data package, a data change record is recorded on the corresponding block.

In addition to what is noted above, the adapter uses different plug-in modes for different blockchains to complete activating and recording blockchain transactions. The plug-in is also used for tracking new blocks in the blockchain and extracting the data package from the transaction records in the block.

In addition to what is noted above, the blockchain performs global consensus through a global consensus mechanism for the data changes recorded by a single node and synchronizes the changes to all nodes with block distribution for consensus voting. If the new data record global consensus fails, a local database rollback operation is executed to revert the data to the pre-transaction state.

Consensus checks the legality or validity of database transactions. The rules include but are not limited to (1) the database operation is submitted by the legal submitter, (2) each submitter can submit data that meets the data range and data format specified in the contract, (3) the relationship between the data complies with business logic, and (4) the submitted data does not conflict with other data recorded in the blockchain, specifically the original state of the submitted data should be consistent with the result of the last recorded change in the blockchain. Inconsistencies indicate that there may be some data changes that have not been verified by the blockchain contract, so the new change record is also invalid.

In addition to what is noted above, the database blockchain adapter monitors all transactions in all blocks of the blockchain, filters out transactions that match the characteristics of the local data desired, and writes the data change record, which passes the global consensus validation to the local database.

In addition to what is noted above, when a database write operation fails to pass the blockchain consensus authentication, the write operation is discarded, and the adapter restores the data in the database to the state prior to the write operation based on the pre-transaction raw data of the transaction record.

In addition to what is noted above, for some database records, if any pending data change operations are waiting for global consensus, the new database change operation fails to execute. If it has already been executed in a node's local database, the operation is rolled back.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A system comprising:
a) a first adapter in communication with a first database and a blockchain;
b) a second adapter in communication with a second database and the blockchain;
the blockchain comprising at least a first node and a second node, a first application running on the first node using the first database: a second application running on the second node using the second database;
wherein the first and second adapters monitor transaction logs for the first and second databases respectively to:
i) extract data operations from the transaction logs;
ii) convert the data operations to a general format; and
iii) activate a smart contract on the blockchain to complete consensus voting at said first and second nodes.

2. The system of claim 1, further comprising said blockchain.

3. The system of claim 1, wherein the first adapter includes:
a) a first plug-in for interfacing with the blockchain; and
b) a second plug-in for monitoring transaction logs of the first database.

4. The system of claim 3, wherein the second adapter includes:
a) a third plug-in for interfacing with the blockchain; and
b) a fourth plug-in for monitoring transaction logs of the second database.

5. The system of claim 4, wherein said transaction logs of the first database result from modification of the first database by the first application.

6. The system of claim 5, wherein said transaction logs of the second database result from modification of the second database by the second application.

7. The system of claim 4, wherein the second plug-in is used for real-time listening or monitoring of transaction logs of the first database.

8. The system of claim 4, wherein the fourth plug-in is used for real-time listening or monitoring of transaction logs of the second database.

9. A method of migrating a database application using a database to a blockchain, comprising:
a) monitoring a log of the database and identifying a database command to be validated by the blockchain;
b) providing a status column in the database for a table affected by the identified database command;
c) executing a first command, based on the database command, to set the status column to a first value;
d) submitting a blockchain command corresponding to the identified database command to the blockchain for validation;
e) upon receiving validation from the blockchain, updating the database by executing a second command, based on the database command, to set the status to a second value different from the first value; and
f) otherwise rolling back the database command.

10. The method of claim 9, wherein the database is a relational database management system (RDBMS).

11. The method of claim 9, wherein the database is NoSQL.

12. The method of claim 9, where the application is not modified.

13. The method of claim 9, further comprising an adapter for performing steps a) to f).

14. The method of claim 13, wherein the adapter further performs the steps of:
a) monitoring blockchain transactions in all new blocks on the blockchain;
b) identifying block transactions affecting the database;
c) converting identified block transactions into new database commands; and
d) executing the new database commands on the database.

15. A system for migrating a database application using a database to a blockchain application using a blockchain, without modifying the application, the system comprising:
an adapter comprising a database proxy and a blockchain interface, the adapter comprising processor executable instructions that when executed on a processor configure the processor to perform the steps of:
i) monitoring a log of the database;
ii) identifying a database command requiring validation by the blockchain from the log;
iii) providing a status column in the database for a table affected by the database command;
iv) executing a first command, based on the database command, to set the status column to a first value;
v) submitting a blockchain command corresponding to the database command to the blockchain for validation;
vi) upon receiving validation from the blockchain, updating the database by executing a second command, based on the database command, to set the status to a second value different from the first value; and
vii) otherwise rolling back the database command.

16. A method of synchronizing database applications running on multiple nodes to a blockchain, the method comprising:
a) monitoring transaction logs for databases used by the applications as the databases are modified by database applications;
b) extracting data operations from transaction logs;
c) converting the data operations to a general format;
d) activating a smart contract on the blockchain to complete the data consensus check at said multiple nodes.

17. A method of synchronizing a first database associated with a first node of a blockchain with a second database associated with a second node on the blockchain, the method comprising:
at the first node:
i) retrieving a log from a message queue of transaction logs for the first database;
ii) identifying a transaction from the log and storing the transaction data in a predetermined format;
iii) invoking a smart contract based the log to store the transaction data into a blockchain;
at the second node:
iv) retrieving the transaction data from the blockchain;
v) executing a first command associated with the transaction data to store the transaction in the second database.

18. The method of claim 17, where the predetermined format is JavaScript Object Notation (JSON).

19. The method of claim 17, wherein the first command is a structured query language (SQL) command.

20. The method of claim 17, further comprising synchronizing a first database with a third database associated with a third node on the blockchain, the method further comprising:
at the third node:
i) retrieving the transaction data from the blockchain;
ii) executing a second command associated with the transaction data to store the transaction in the third database.
